(19) United States
(12) Patent Application Publication
(10) Pub. No.: US 2007/0128376 A1
(43) Pub. Date: Jun. 7, 2007

(54) Resin sheet, liquid crystal cell substrate, liquid crytal display device, substrate for an electroluminescence display device, electroluminescence display device, and substrate for a solar cell

(75) Inventors: Tadaaki Harada, Osaka (JP); Yuuzou Akada, Osaka (JP); Yoshimasa Sakata, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, OSAKA (JP)

(21) Appl. No.: 10/580,714

(22) PCT Filed: Nov. 24, 2004
(86) PCT No.: PCT/JP04/17416

§ 371 Date: May 25, 2006

(30) Foreign Application Priority Data
Nov. 25, 2003 (JP) 2003-394044

(51) Int. Cl. C09K 19/00

(52) U.S. Cl. 428/1.1; 428/690

(57) ABSTRACT

There is provided a resin sheet that achieves improvement in lightweight, low-profile and high impact characteristics, suppresses thermal shrinkage and expansion and is excellent in light transparency so as to prevent the display quality or the like of a display device from being deteriorated, as well as a substrate for a display device, a display device and a substrate for a solar cell, each having the aforesaid resin sheet. A resin sheet includes a cured resin layer containing in a resin a glass fiber cloth-like material and inorganic particles, and is structured to have a haze value of 10% or lower.

### FIELD OF THE INVENTION

The present invention relates mainly to a resin sheet suitable for use in a display device, as well as a substrate for a display device, a display device and a substrate for a solar cell, each including the resin sheet.

### BACKGROUND OF THE INVENTION

For liquid crystal display devices, electroluminescence display devices and the like, it is proposed to use plastic substrates in place of conventional glass substrates for progress in making displays lightweight, low-profile and high impact. Whilst substrates of the above type are required to have a low coefficient of thermal expansion, plastic substrates may pose a problem of causing misalignment when forming, for example, electrodes or color filters, due to thermal shrinkage and expansion, since plastic has a higher coefficient of linear expansion than glass.

Although those of various active matrix driving types are recently used especially in the field of liquid crystal display devices thanks to the excellent display quality compared with passive matrix driving types, the above problem is more significant in the liquid crystal display devices of the active matrix driving types because they are required to have a lower coefficient of thermal expansion than the passive matrix driving types.

Another problem associated with plastic substrates is that the mechanical strength thereof is relatively low.

In light of the above problems, there is proposed a resin sheet for a substrate that includes a cured resin layer having a glass fiber cloth-like material embedded therein by impregnating the glass fiber cloth-like material with a pre-cured resin, molding it into a sheet and curing the same, in which the glass fiber cloth-like material is formed by weaving glass fibers into cloth (Patent documents 1, 2 referred below).

Patent Document 1: Official Gazette of Japanese Patent Application Laid-open No. 2003-50384

Patent Document 2: Official Gazette of Japanese Patent Application Laid-open No. Hei-11-2812

### SUMMARY OF THE INVENTION

### Problems to be solved by the Invention

However, in a resin sheet for a substrate manufactured by embedding a glass fiber cloth-like material in a cured resin layer, the cured resin layer is resultingly made up of two components, namely glass and resin, and therefore light transmitted therethrough may be diffused causing undesirable effects on light transparency.

The thus arranged resin sheet is easy to have an irregular surface due to such as the shape of the glass fiber cloth-like material, which may cause undesirable effects on light transparency.

Accordingly, it is an object of the present invention to provide a resin sheet that achieves improvement in lightweight, low-profile and high impact characteristics, suppresses thermal shrinkage and expansion and is excellent in light transparency so as to prevent the display quality or the like of a display device from being deteriorated, as well as providing a substrate for a display device, a display device and a substrate for a solar cell, each having the aforesaid resin sheet.

### Means of Solving the Problems

In consideration of the above problems, according to the present invention, there is provided a resin sheet, characterized in that it includes a cured resin layer containing in a resin a glass fiber cloth-like material and inorganic particles, and is structured to have a haze value of 10% or lower.

In the present invention, a haze value may be measured according to, for example, JIS K 7136, and is measured specifically by using a commercially available hazemeter (e.g., “HM-150”, trade name; manufactured by Murakami Color Research Laboratory).

### Effects of the Invention

With the resin sheet of the present invention, the cured resin layer with the glass fiber cloth-like material contained in the resin can realize lightweight, low-profile, and improvement in impact resistance, and suppress thermal shrinkage and expansion. Therefore, it is possible to prevent misalignment of an electrode, a color filter or the like as mentioned above when used as a liquid crystal cell substrate for forming a liquid crystal panel.

In the resin sheet of the present invention, inorganic particles are contained in the resin so that it is possible to more effectively prevent thermal shrinkage and expansion of the cured resin layer and prevent causing unevenness or irregularities due to the difference in coefficient of linear expansion between the glass fiber cloth-like material and the resin in a cooling step subsequent to heating and curing the resin. In addition, the resin sheet is structured to have a haze value of 10% or lower, thereby achieving reduced light diffusion and thus providing a resin sheet that is remarkably excellent in light transparency. Therefore, when used as a liquid crystal cell substrate, a substrate for an electroluminescence display device or the like, the display quality of a display device becomes excellent. Furthermore, a substrate for a solar cell including the resin sheet may contribute to the improvement in power generating efficiency of the solar cell.

### BRIEF DESCRIPTION OF THE DRAWINGS

FIG. 1 is a cross sectional view illustrating a resin sheet according to one embodiment.

FIG. 2 is a cross sectional view illustrating a resin sheet according to another embodiment.

### DESCRIPTION OF THE REFERENCE CODES

1: cured resin layer

2: glass fiber cloth-like material

3: inorganic particles

4: gas barrier layer

5: hard-coat layer

10: resin sheet

### BEST MODE FOR CARRYING OUT THE INVENTION

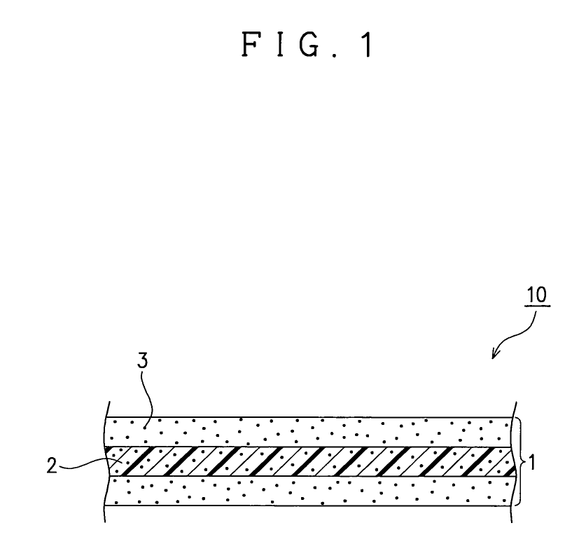

As illustrated in FIG. 1, a resin sheet 10 of the present invention includes a cured resin layer 1 containing in a resin a glass fiber cloth-like material 2 and inorganic particles 3, and is structured to have a haze value of 10% or lower.

Examples of the glass fiber cloth-like material include fabric, non-woven fabric and knitted fabric; and specifically, known commercially available products such as glass non-woven fabric, roving cloth, chopped strand mat and unidirectional woven roving (cord fabric), as well as commonly used glass cloth produced by weaving yarns can be used.

The glass fiber cloth-like material has a density preferably in a range from 10 to 500 g/m², more preferably in a range from 20 to 350 g/m² and still more preferably in a range from 30 to 250 g/m². The glass fiber has a filament diameter of preferably 3 to 15 μm, more preferably 5 to 13 μm, and still more preferably 5 to 10 μm. As a material of the glass fiber, soda glass, borosilicate glass, no alkali glass, etc., are used; and of them, no alkali glass is preferable since alkali components may cause undesirable effects on a TFT or the like.

The glass fiber cloth-like material has a thickness of preferably 10 to 500 μm, more preferably 15 to 350 μm and still more preferably 30 to 250 μm.

Inorganic particles used in the present invention preferably have a mean particle diameter of 100 nm or smaller, more preferably 70 nm or smaller and still more preferably 50 nm or smaller.

The inorganic particles having such particle diameters are contained in a cured resin layer preferably in a range of 15 to 60 wt. %, and more preferably in a range of 25 to 50 wt. %. With the inorganic particles contained less than 15 wt. %, the coefficient of linear expansion of the cured resin layer is reduced so that the difference in shrinkage ratio with respect to the glass fiber cloth-like material is increased, which may lead to cause unevenness or irregularities in a cooling step after the curing, and hence cause undesirable effects on the surface smoothness. With the inorganic particles contained more than 60 wt. %, the viscosity of the resin is excessively high during a cured resin layer is formed, which may lead to deterioration in workability.

The mean particle diameter of the inorganic particles is a value calculated as a mean value of ten particles based on the measurement of the major axis of each of the ten particles on a vertically cut surface of a cured resin layer.

With respect to the kind of the inorganic particles, inorganic oxides such as silica, titanium oxide, antimony oxide, titania, alumina, zirconia and tungsten oxide may be used. Of them, silica is preferable since it can be evenly dispersed in a resin, and the resulting resin sheet has a high transparency and a low coefficient of linear expansion.

As a resin forming a cured resin layer, thermosetting resins or UV curing resins, such as polyethersulfone, polycarbonate, epoxy resins, acryl resins or various optical polyolefin resins may be used. Of them, epoxy resins are preferably used since they are excellent in surface smoothness and color hue.

A cured resin layer that contains the glass fiber cloth-like material and the inorganic particles has a thickness of preferably 20 to 800 μm. With a thickness of less than 20 μm, poor strength or stiffness may be caused, and with a thickness of more than 800 μm, advantages of a resin sheet such as low profile and light weight may be decreased.

As an epoxy resin, it is possible to use hitherto known epoxy resins, which include bisphenol types such as bisphenol A type, bisphenol F type, bisphenol S type, and hydrogenated epoxies derived from these; novolak types such as phenol novolak type and cresol novolak type; nitrogen-containing cyclic types such as triglycidyl isocyanurate type and hydantoin type; alicyclic types; aliphatic types; aromatic types such as naphthalene type; low-water-absorption types such as glycidyl ether type and biphenyl type; dicyclo types such as dicyclopentadiene type; ester types; etherester types; and modifications of these.

Of these epoxy resins, preferred epoxy resins from the standpoints of unsusceptibility to discoloration, etc., are bisphenol A type epoxy resin, alicyclic type epoxy resin and triglycidyl isocyanulate type epoxy resin. These epoxy resins may be used alone or in combination of two or more thereof.

Examples of the dicyclopentadiene type epoxy resin (an epoxy resin having the skeleton of dicyclopentadiene) include epoxy resins respectively represented by the following formula (1), (2). In the formula (2), n represents an integer of 1 to 3.

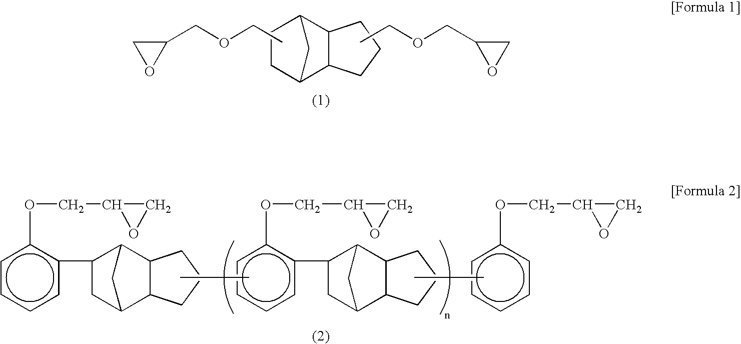

By the use of the epoxy resin represented by the formula (1) or (2), it is possible to control the thicknesswise retardation of a resin sheet to a small value. When the thicknesswise retardation is small, it is possible to suppress light leakage in an oblique direction in a black display mode when the laminated film is used in a liquid crystal display device. Thus, the display characteristics are more improved.

From the standpoint of improving, for example, the flexibility or strength of a resin sheet to be formed, the epoxy resin preferably has an epoxy equivalent of 100 to 1000 (g/eq) and a softening point of 120° C. or below. The epoxy resin preferably remains in a liquid state at ordinal temperature (e.g., 5 to 35° C.). For forming a resin sheet, it is preferable to use a two-component epoxy resin that remains in a liquid state at a temperature equal to or lower than the temperature at which the coating is carried out, or particularly at ordinal temperature, since it is excellent in spreading property and coatability.

The cured resin layer may be mixed with various types of additives other than resins, according to needs and circumstances.

Examples of the additives include curing agents, curing accelerators, age resistors, modifying agents, surfactants, colorants, pigments, discoloration inhibitors and UV absorbers.

Examples of the curing agent include without limitation organic acid compounds such as tetrahydrophthalic acid, methyltetrahydrophthalic acid, hexahydrophthalic acid and methylhexahydrophthalic acid, and amine compounds such as ethylenediamine, propylenediamine, diethylenetriamine, triethylenetetramine, amine adducts thereof, methaphenylenediamine, diaminodiphenylmethane and diaminodiphenylsulfone. These may be used alone or in combination of two or more thereof.

Further examples of the curing agent include amide compounds such as dicyandiamide and polyamide, hydrazide compounds such as dihydrazide, imidazole compounds such as methylimidazole, 2-ethyl-4-methylimidazole, ethylimidazole, isopropylimidazole, 2,4-dimethylimidazole, phenylimidazole, undecylimidazole, heptadecylimidazole and 2-phenyl-4-methylimidazole, imidazoline compounds such as methylimidazoline, 2-ethyl-4-methylimidazoline, ethylimidazoline, isopropylimidazoline, 2,4-dimethylimidazoline, phenylimidazoline, undecylimidazoline, heptadecylimidazoline and 2-phenyl-4-methylimidazoline, phenol compounds, urea compounds and polysulfide compounds.

In addition, acid anhydrides and the like may be used as the curing agent, and these acid anhydrides are preferably used from the standpoints of, for example, discoloration inhibiting characteristics. Examples of these acid anhydrides include phthalic anhydride, maleic anhydride, trimellitic anhydride, pyromellitic anhydride, nadic anhydride, glutaric anhydride, tetrahydrophthalic anhydride, methyltetrahydrophthalic anhydride, hexahydrophthalic anhydride, methylhexahydrophthalic anhydride, methylnadic anhydride, dodecenylsuccinic anhydride, dichlorosuccinic anhydride, benzophenonetetracarboxylic anhydride and chlorendic anhydride. Of these acid anhydrides, it is preferable to use colorless or pale yellow acid anhydride curing agents having a molecular weight of from about 140 to about 200, such as phthalic anhydride, tetrahydrophthalic anhydride, hexahydrophthalic anhydride, methylhexahydrophthalic anhydride or methylnadic anhydride.

When an epoxy resin is used as a resin that forms the cured resin layer, no limitation is intended on the amount of the curing agent to be added in the epoxy resin; but when an acid anhydride curing agent is used as a curing agent, an acid anhydride is added in an amount of, for example, preferably from 0.5 to 1.5 equivalents, and more preferably from 0.7 to 1.2 equivalents, per equivalent of epoxy group in the epoxy resin. With the acid anhydride curing agent added in an amount of 0.5 equivalents or more, it is possible to make the color tint after curing more significant, and with being 1.5 equivalents or less, satisfactory moisture resistance can be kept. In a case where a different curing agent is used, or two or more types of the curing agents are used, it is possible to mix them according to the aforesaid equivalent ratio.

Examples of the curing accelerator include without limitation tertiary amines, imidazoles, quaternary ammonium salts, quaternary phosphonium salts, organic metal salts, phosphorus compounds and urea compounds, and of them, tertiary amines, imidazoles and quaternary phosphonium salts are preferable. These curing accelerators may be used alone or in combination of two or more thereof.

The amount of the curing accelerator to be added in the cured resin layer is not limited to a specific amount, but may be determined depending on the type of the resin or the like. For example, when an epoxy resin is used, the curing accelerator is added in an amount of preferably from 0.05 to 7.0 parts by weight, and more preferably from 0.2 to 3.0 parts by weight, per 100 parts by weight of the epoxy resin. With the curing accelerator added in an amount of 0.05 parts by weight or more, satisfactory curing acceleration effect can be produced, and when in an amount of 7.0 parts by weight or less, it is possible to make the color tint after curing significant.

Examples of the age resistor include without limitation phenol compounds, amine compounds, organic sulphur compounds, phosphine compounds and other hitherto known compounds.

Examples of the modifying agent include without limitation glycols, silicones, alcohols and other hitherto known compounds.

Examples of the surfactant include various types of surfactants such as silicone, acrylic or fluorinated surfactants. Of them, silicone surfactant is preferable. These surfactants are added to smoothen the surface of a resin sheet when the resin sheet is to be formed, for example, by curing a resin in contact with air by a flow-casting method or the like.

In a resin sheet of the present invention, the absolute value of the difference in refractive index between a resin, which forms a cured resin layer, and a glass fiber cloth-like material is from 0 to 0.01, preferably from 0 to 0.008, and more preferably from 0 to 0.006. The absolute value of the difference in refractive index is preferably equal to or less than 0.01, since interface scattering between the glass fiber cloth-like material and the resin, which forms a cured resin layer, in the cured resin layer is suppressed, thereby enabling decreasing the haze and hence satisfactorily maintaining the original transparency of the cured resin layer.

The refractive index may be measured by use of an Abbe refractometer at 25° C. and 589 nm.

A resin sheet of the present invention preferably has a coefficient of linear expansion that is equal to or less than 3.00×10⁻⁵/° C. at a temperature from 25° C. to 160° C. When the coefficient of linear expansion is equal to or less than the aforesaid value for a laminated film of the present invention, which is used as, for example, a liquid crystal cell substrate on which a color filter, an electrode, etc., are formed, it is possible to satisfactorily suppress misalignment or the like therebetween due to thermal expansion, and hence more easily form a color filter, etc. The coefficient of linear expansion is more preferably equal to or less than 2.00×10⁻⁵/° C., and still more preferably equal to or less than 1.5×10⁻⁵/° C.

The coefficient of linear expansion is determined by obtaining a TMA measured value by the TMA method specified in JIS K 7197 for an object to be measured and substituting it into the following expression. In the following expression, ΔIs(T₁) and ΔIs(T₂) represent TMA measured values (μm) respectively obtained at a temperature T₁(° C.) and a temperature T₂(° C.), at which the measurement is carried out, and Lₒ represents a length (mm) of an object to be measured, at a room temperature of 23° C.
Coefficient of linear expansion=[1/(Lₒ×10³)]·[(ΔIS(T₂)−ΔIs(T₁))/(T₂−T₁)]

A resin sheet of the present invention preferably has a light transmittance of 88% or higher. When the light transmittance is 88% or higher, it is possible to provide more crisp characters or images in various types of image display devices, and thus achieving more excellent display quality, when those image display devices each are assembled by using a resin sheet of the present invention as a liquid crystal cell substrate, a substrate for an electroluminescence display device, or the like.

The light transmittance may be determined by measuring a total transmittance of light rays with a wavelength of 550 nm, using a high-speed spectrophotometer.

A resin sheet of the present invention may have an outermost layer having a surface roughness Rt of 350 μm or less and preferably 300 μm or less, so as to be excellent in surface smoothness and transparency.

In the present invention, the “surface roughness Rt” represents a difference between a maximum value and a minimum value, which are obtained by measurement using a stylus type surface roughness meter (e.g., “P-11”, trade name; manufactured by KLA-Tencor Ltd.) under a condition of a long wavelength cut-off of 800 μm, a short wavelength cut-off of 250 μm, and an evaluation length of 10 mm.

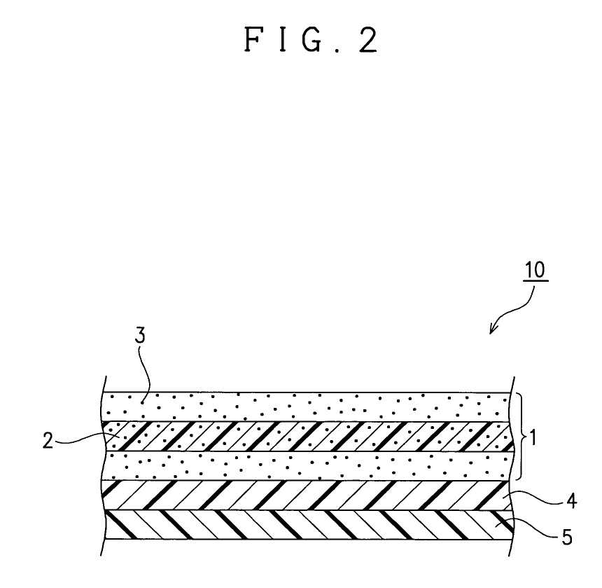

A resin sheet of the present invention is preferably a laminated body that further includes at least one of a hard-coat layer, which is harder than the cured resin layer, and a gas barrier layer, which is more excellent in gas barrier properties than the cured resin layer. Particularly, as illustrated in FIG. 2, the resin sheet is preferably a laminated body that includes both a hard-coat layer 5 and a gas barrier layer 4 with the hard-coat layer 5 laminated as an outermost layer. With the hard-coat layer laminated as an outermost layer, it is possible to improve abrasion resistance, etc., of the resin sheet. In various types of image display devices such as a liquid crystal display device, when moisture or oxygen passes through a liquid crystal cell substrate and enters the inside of the liquid crystal cell, the quality of a liquid crystal changes and bubbles are formed, which may cause poor appearance, break of a conductive layer pattern or the like. However, the gas barrier layer as laminated can prevent passing-through of gas such as moisture and oxygen. The hard-coat layer and the gas barrier layer may be laminated on either side or both may be laminated on each of both sides. However, it is preferable to laminate a hard-coat layer on at least one side, on which a polarizing plate is not laminated.

In a case where both a hard-coat layer and a gas barrier layer are laminated, the order, in which they are laminated, is not necessarily limited to a specific order; but it is preferable to laminate first a gas barrier layer and then a hard-coat layer onto the cured resin layer. Particularly, the hard-coat layer is preferably laminated as an outermost layer since it is excellent in impact resistance, chemical resistance, etc.

Examples of a material for forming the hard-coat layer include without limitation urethane resins, acrylic resins, polyester resins, polyvinyl alcohol resins such as polyvinyl alcohol, ethylene vinyl alcohol copolymer, vinyl chloride resins and vinylidene chloride resins. For example, it is possible to use polyarylate resins, sulfone resins, amide resins, imide resins, polyether sulfone resins, polyether imide resins, polycarbonate resins, silicone resins, fluororesins, polyolefin resins, styrene resins, vinylpyrrolidone resins, cellulose resins, acrylonintrile resins, etc. Of them, urethane resins are preferable, and urethane acrylate is more preferable. These resins may be used alone or in combination of two or more as a blended resin.

Although no limitation is intended, the thickness of the hard-coat layer is, for example, in a range from 0.1 to 50 μm, preferably from 0.5 to 8 μm, and more preferably from 2 to 5 μm, from the standpoints of ease to remove and prevention of occurrence of cracking due to the removal, when manufacturing.

The gas barrier layer is categorized into, for example, an organic gas barrier layer and an inorganic gas barrier layer. Examples of a material for forming the organic gas barrier layer include without limitation polyvinyl alcohol and a partially saponified product thereof, vinyl alcohol polymers such as ethylene vinyl alcohol copolymer, materials with low oxygen-permeability such as polyacrylonitrile, and polyvinylidene chloride. Of these materials, vinyl alcohol polymers are particularly preferably used from the standpoint of their high gas barrier properties.

From the standpoints of, for example, functionality in terms of transparency, prevention of coloration, gas barrier properties and the like, as well as reduction in thickness, flexibility of a resulting resin sheet and the like, the thickness of the organic gas barrier layer is, preferably 10 μm or smaller, more preferably from 2 to 10 μm, and still more preferably from 3 to 5 μm. In the resin sheet, with the thickness being 10 μm or smaller, a lower yellow color index (YI value) may be maintained, and with the thickness being 2 μm or greater, satisfactory gas barrier performance can be maintained.

Meanwhile, as a material for forming an inorganic gas barrier layer, for example, transparent materials such as silicon oxides, magnesium oxides, aluminum oxides, zinc oxides and the like may be used. Of these materials, silicon oxides and silicon nitrides are preferably used from the standpoints of, for example, their excellent gas barrier properties, adhesion to the substrate layer and the like.

Preferably, the silicon oxides have, for example, a ratio of the number of oxygen atoms to the number of silicon atoms of 1.5 to 2.0 for the following reason. That is, with this ratio, the inorganic gas barrier layer is improved further in terms of, for example, gas barrier properties, transparency, surface smoothness, bending properties, membrane stress, cost, and the like. In the silicon oxides, the maximum value of the ratio of the number of oxygen atoms to the number of silicon atoms is 2.0.

The silicon oxides preferably have a ratio (Si:N) of the number of nitrogen atoms (N) to the number of silicon atoms (Si) of 1:1 to 3:4.

Although no limitation is intended, the inorganic gas barrier layer has a thickness preferably in a range of, for example, from 5 to 200 nm. With the thickness being 5 nm or greater, for example, more excellent gas barrier properties can be obtained, and with the thickness being 200 nm or smaller, the inorganic gas barrier layer is improved also in terms of transparency, bending properties, membrane stress, and cost.

When a resin sheet of the present invention is a laminated body, its thickness, which varies depending on the number of layers laminated, is preferably for example in the range from 30 to 800 μm. The resin sheet having such a thickness fully exerts advantages of the resin sheet, namely excellent strength and stiffness, low-profile, lightweight, etc.

Although a method of manufacturing a resin sheet of the present invention is not necessarily limited to a specific method, it is preferably manufactured by employing a cast-molding method, a flow-casting method, an impregnation method or a coating method. Specifically, the resin sheet is manufactured in the manner mentioned below.

When the cast-molding method is employed, for example, a hard-coat layer is first formed on a flat plate mold, then a glass fiber cloth-like material is placed on the hard-coat layer, then a liquid resin for forming a cured resin layer is coated on the glass fiber cloth-like material, and then the glass fiber cloth-like material is impregnated with the resin by setting a condition of a reduced pressure. Then, the flat plate mold having the hard-coat layer formed thereon is laid on the cured resin layer, and these resins are cured so that a resin sheet can be formed.

A cured resin layer with a glass fiber cloth-like material having a resin impregnated therein may be formed by impregnating the glass fiber cloth-like material with a liquid resin and then curing the resin at normal pressure.

Inorganic particles may be previously dispersed in a resin by, for example, sol-gel reaction when a resin is coated on the glass fiber cloth-like material.

In a case where a resin sheet having a gas barrier layer is formed by the cast-molding method, a gas barrier layer is formed on any one of the opposite hard-coat layers, and they are laid on the cured resin layer in the same manner as mentioned above, thereby enabling forming a resin sheet. A gas barrier layer may be formed in a separate step, and for example, a resin sheet after having been removed from a flat plate mold may be provided on any one or each of the opposite sides thereof with a gas barrier layer.

In a case where a resin sheet of the present invention is formed by the flow-casting method, it may be formed by having a hard-coat layer and a gas barrier layer formed in this order on an endless belt or separator, made of stainless steel or the like, then laminating thereon a glass fiber cloth-like material with a resin impregnated therein, and curing them. A hard-coat layer and a gas barrier layer may be eliminated according to needs and circumstances. Alternatively, it is possible to have a glass fiber cloth-like material first placed on an endless belt or a separator and then coated and impregnated with a resin solution on the endless belt or separator.

When impregnating a glass fiber cloth-like material with a resin for forming a cured resin layer, the resin may be dispersed or dissolved in a solvent, thereby preparing a liquid resin for use.

A resin sheet of the present invention may be used for various purposes, and may be appropriately used for a liquid crystal cell substrate, a substrate for an electroluminescence display device and a substrate for a solar cell.

A liquid crystal display device is generally made up of a polarizing plate, a liquid crystal cell and a reflection plate or a backlight, as well as any elements such as other optical parts appropriately assembled according to needs and circumstances, and a driving circuit incorporated thereinto. A liquid crystal display device of the present invention may be made up of those elements in the same manner as a conventional device, except that a liquid crystal cell is formed by using a liquid crystal cell substrate that uses the aforesaid resin sheet.

Therefore, it is possible to combine the aforesaid resin sheet with an appropriate optical part such as a diffusion plate, an antiglare layer, an antireflection film, a protection layer or a protection plate provided on a polarizing plate on a visible side, or a compensating retardation plate provided between a liquid crystal cell and a polarizing plate on a visible side.

An electroluminescence display device has a luminescence element that is generally made up of a transparent electrode, an organic ruminant layer containing a luminant (an organic electroluminescence ruminant) and a metal electrode laminated in a certain order on a transparent substrate. An electroluminescence display device of the present invention may be made up of those elements in the same manner as a conventional device, except that the aforesaid resin sheet is used as the transparent substrate.

### EXAMPLES

The present invention will be described by citing the following examples, which are not intended to limit the present invention.

### Example 1

An epoxy resin liquid with 31.5 wt. % of silica particles contained in a cured resin layer was prepared by using 3,4-epoxycyclohexylmethyl-3,4-epoxycyclohexane carboxylate (“NANOPOX XP22/0316”, trade name; manufactured by hanse chemie AG) by an amount equivalent to 24.6 parts by weight (hereinafter referred only to parts), which is represented by the following formula (3), in which silica particles (mean particle diameter of 15 nm) as inorganic particles are evenly dispersed by sol-gel reaction, and stirring and mixing it with: 6.9 parts of a dicyclopentadiene type epoxy resin (“EXA-7320”, trade name (epoxy equivalent of 259); manufactured by Dainippon Ink And Chemicals, Incorporated) represented by the following formula (4); as a curing agent, 36.2 parts of methylnadic anhydride; and as a curing accelerator, 0.72 parts of tetra-n-butylphosphonium o,o-diethylphosphorodithioate represented by the following formula (5).

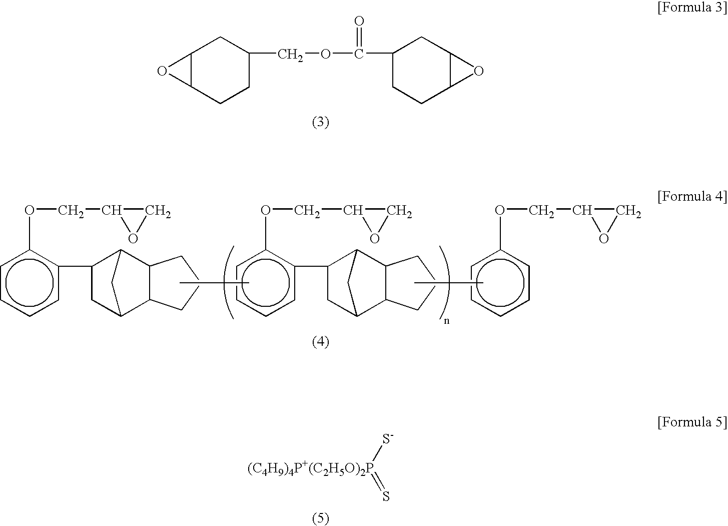

Then, the aforesaid epoxy resin liquid was impregnated into a glass fiber cloth-like material (“NEA2116F S136”, trade name; manufactured by Nitto Boseki Co., Ltd., a thickness of 90 μm, a refractive index of 1.513), and left to stand for 60 minutes under a condition of a reduced pressure (200 Pa).

Then, a hard-coat layer having a thickness of 2 μm was formed by flow-casting a toluene solution having 17 wt. % of urethane acrylate represented by the following formula (6) from a die onto an endless belt of stainless steel at a running speed of 0.3 m/min., air-drying it to volatilize toluene and curing the remaining by using a UV curing device. Subsequently, the glass fiber cloth-like material with the epoxy resin liquid impregnated thereinto was laminated thereon, and was cured by using a heating device. Thus, a laminate with the hard-coat layer and the cured resin layer laminated together, having a thickness of 100 μm, was obtained. According to the measurements separately made, a portion of the cured resin layer other than the glass fiber cloth-like material had a refractive index of 1.516 and had a refractive index difference of 0.003 with respect to the glass fiber cloth-like material.

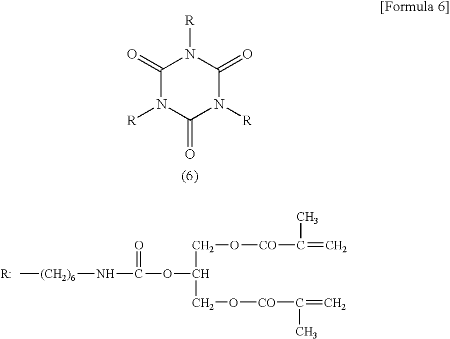

### Example 2

A resin sheet was prepared in the same manner as in Example 1 except that 23 wt. % of silica particles were contained in a cured resin layer.

### Comparative Example 1

A resin sheet was prepared in the same manner as in Example 1 except that no silica particles were contained.

### Comparative Example 2

A resin sheet was prepared in the same manner as in Example 1 except that a glass cloth (manufactured by Nitto Boseki Co., Ltd.) having a refractive index of 1.558 and a thickness of 100 μm was used as a glass fiber cloth-like material. In a cured resin layer, the refractive index difference between the glass fiber cloth-like material and a portion other than the glass fiber cloth-like material was 0.042.

### Evaluation Test

For the resin sheets of Examples and Comparative Examples, measurement was made for each of the coefficient of linear expansion, bending properties, light transmittance and surface roughness. The measurements each were made as follows:

Coefficient of Linear Expansion (/° C.): Using a TMA/SS150C, trade name (manufactured by Seiko Instruments Inc.), TMA values (μm) at temperatures of 25° C. and 160° C. were respectively measured, and determination was performed.

Bending Properties: Each of the resin sheets was wound around a steel mast having a diameter of 35 mm, and a visual observation was performed to check if a crack had been caused.

Light Transmittance: A light transmittance of λ=550 nm was measured using a high-speed spectrophotometer (“CMS-500”, trade name; manufactured by Murakami Color Research Laboratory, using a halogen lamp).

Surface Roughness: A surface roughness (difference between a maximum value and a minimum value) was measured using a stylus type surface roughness meter (“P-11”, trade name; manufactured by KLA-Tencor Ltd.) under a condition of a long wavelength cut-off of 800 μm, a short wavelength cut-off of 250 μm, and an evaluation length of 10 mm.

Haze Value: With respect to each of the resin sheets, a haze value was measured using a hazemeter (“HM-150”, trade name; manufactured by Murakami Color Research Laboratory).

The results are shown in Table 1.

TABLE 1

| | | | Comparative | Comparative |
|---|---|---|---|---|
| | Example 1 | Example 2 | Example 1 | Example 2 |
| Refractive | 0.003 | 0.003 | 0.003 | 0.042 |
| Index | | | | |
| Difference | | | | |
| Inorganic | 31.5 wt. % | 23.0 wt. % | Nil | 31.5 wt. % |
| Particles | | | | |
| Coefficient | 5 × 10⁻⁵/° C. | 6 × 10⁻⁵/° C. | 8 × 10⁻⁵/° C. | 5 × 10⁻⁵/° C. |
| of Linear | | | | |
| Expansion | | | | |
| Bending | No Crack | No Crack | No Crack | No Crack |
| Properties | | | | |
| Light | 88% | 89% | 89% | 88% |
| Transmittance | | | | |
| Surface | 200 nm | 300 nm | 500 nm | 200 nm |
| Roughness | | | | |
| (Rt) | | | | |
| Haze Value | 3% | 3% | 3% | 80% |

As shown in Table 1, the resin sheets of Examples 1 and 2 each had a low coefficient of linear expansion and were excellent in transparency and surface smoothness. Also, the bending properties were excellent. On the other hand, the resin sheet of Comparative Example 1 had a poor surface smoothness compared with those of the Examples, although was excellent in coefficient of linear expansion, light transmittance and bending properties likewise those of the Examples. The resin sheet of Comparative Example 2 had a haze value of 80% and caused turbidity or cloudiness, although was excellent in coefficient of linear expansion, light transmittance, bending properties and surface smoothness likewise those of the Examples.

A transmissive liquid crystal display device was assembled by using the resin sheet of each of the Examples and the Comparative Examples, and there were no problems such as misalignment, break or the like in forming an oriented film, patterning a color filter layer and forming a liquid crystal cell.

Meanwhile, in a liquid crystal display device using the resin sheet of Comparative Example 1, deterioration in image quality, which is seemed to be due to a specific surface smoothness of the resin sheet was confirmed.

A transmissive liquid crystal display device using the resin sheet of Comparative Example 2 did not fully carry out the function as a display device due to turbidity or cloudiness on the display.

1. A resin sheet, characterized in that it comprises a cured resin layer containing in a resin a glass fiber cloth-like material and inorganic particles, and is structured to have a haze value of 10% or lower.

2. A resin sheet according to claim 1, wherein a refractive index difference between a resin that forms the cured resin layer, and the glass fiber cloth-like material is 0.01 or less.

3. A resin sheet according to claim 1, wherein the amount of the inorganic particles contained in the cured resin layer is 15 to 60 wt. %.

4. A resin sheet according to claim 1, wherein the inorganic particles are silica particles.

5. A resin sheet according to claim 1, wherein the resin that forms the cured resin layer is an epoxy resin.

6. A resin sheet according to claim 1, whose coefficient of linear expansion is equal to or less than 5.0×10⁻⁵/° C. at 25 to 160° C.

7. A resin sheet according to claim 1, whose light transmittance is 88% or more.

8. A resin sheet according to claim 1, wherein a gas barrier layer is further laminated.

9. A resin sheet according to claim 1, wherein a hard-coat layer is further laminated.

10. A liquid crystal cell substrate, characterized in that it comprises the resin sheet of claim 1.

11. A liquid crystal display device, characterized in that it comprises the liquid crystal cell substrate of claim 10.

12. A substrate for an electroluminescence display device, characterized in that it comprises the resin sheet of claim 1.

13. An electroluminescence display device, characterized in that it comprises the substrate for an electroluminescence display device of claim 12.

14. A substrate for a solar cell, characterized in that it comprises the resin sheet of claim 1.
